(19) United States
(12) Patent Application Publication
(10) Pub. No.: US 2025/0367907 A1
(43) Pub. Date: Dec. 4, 2025

(54) FACE MATERIAL FOR VEHICLE INTERIOR/EXTERIOR MATERIAL AND A METHOD OF MANUFACTURING THE SAME, AS WELL AS VEHICLE INTERIOR/EXTERIOR MATERIAL AND A METHOD OF MANUFACTURING THE SAME

(71) Applicants: Howa Co., Ltd., Kasugai-shi (JP); NAKAMOTO PACKS CO., LTD., Osaka City (JP)

(72) Inventors: Shingo HORIKIRI, Kasugai-shi (JP); Reiichi KONISHI, Osaka City (JP); Ryo NAKAZAWA, Osaka City (JP)

(21) Appl. No.: 19/219,421

(22) Filed: May 27, 2025

(30) Foreign Application Priority Data
May 29, 2024 (JP) 2024-087143

(51) Int. Cl. B32B 7/025; B32B 5/02; B32B 7/12; B32B 27/12; B32B 27/32; B60R 13/00; B60R 16/06

(52) U.S. Cl. CPC B32B 7/025; B32B 5/022; B32B 7/12; B32B 27/12; B32B 27/32; B60R 16/06; B32B 2307/202; B32B 2307/7242; B32B 2605/003; B60R 13/00

(57) ABSTRACT

A face material is integrally arranged with a base material of vehicle interior/exterior materials. The face material has a fiber layer made of nonwoven fabric facing the vehicle body side and a conductive film layer composed of conductive particles adhered to it. The conductive film layer serves as a conductive pathway for diffusing or discharging static electricity charged on the outer surface of the vehicle body while a vehicle is traveling. The resistance value of the conductive film layer is set by adjusting the adhesion amount of the conductive particles. The conductive film layer can be customized by changing the ratio of the adhered area of conductive particles or the film thickness.

### CROSS-REFERENCE TO RELATED APPLICATIONS

This application claims priority to Japanese patent application serial number 2024-087143 filed May 29, 2024, the contents of which are incorporated herein by reference in their entirety for all purposes.

### BACKGROUND

The present invention relates to face materials for vehicle interior/exterior materials and a method of manufacturing the same, as well as vehicle interior/exterior materials and a method of manufacturing the same.

Normally, air carries a positive (+) charge. Therefore, when a vehicle such as an automobile travels, the vehicle body is charged with positive static electricity. This creates a repulsive force (force of repulsion) between the vehicle body and the air. This repulsive force causes the positively (+) charged air to separate from the outer surface of the vehicle body at unintended locations. In other words, the air flow is separated from the flow along the outer surface of the vehicle body. As a result, air resistance increases, which may lead to a reduction in the driving performance and steering stability of the vehicle.

For example, existing technology relates to an electrostatic eliminator that removes static electricity from a specific portion of a vehicle. This electrostatic eliminator includes a conductive resin. The conductive resin may be charged with a negative (−) charge due to external factors. The conductive resin is applied to various specific portions such as a wheel nut and a wheel nut cover in a shape of a tape or a coating. The conductive resin reduces the positive (+) charge on or in the vicinity of the surface of the vehicle body that has been positively charged by external factors. Alternatively, the conductive resin may charge the surface of the vehicle body or its vicinity with a negative (−) charge. This prevents positively (+) charged air from being separated from the surface of the vehicle body.

However, the required electrostatic elimination effect varies depending on the vehicle models and specifications. A resistance value of components and members with electrostatic elimination functions may also need to be adjusted according to the requirements. From the perspective of maintaining the appearance of the vehicle body, it is preferred to arrange electrostatic eliminating members in portions that are not visible from the outside, such as the interior of the vehicle body. Therefore, adjusting the resistance value according to the specific requirements of different vehicle models and specifications is crucial for maintaining optimal vehicle dynamics, and there is a need for an electrostatic elimination function to make such adjustment possible.

It has been desired to have a face material for vehicle interior/exterior materials having an electrostatic elimination function and capable of adjusting a resistance value according to the requirements of different electrostatic elimination effects depending on the vehicle and a method of manufacturing the same, as well as vehicle interior/exterior materials and a method of manufacturing the same.

### SUMMARY

According to one aspect of the present disclosure, a face material for vehicle interior/exterior materials is integrally arranged with a base material of vehicle interior/exterior materials. The face material includes a fiber layer, which is a sheet-like nonwoven fabric, and a conductive film layer composed of conductive particles adhered to at least some areas on one side of the fiber layer. The conductive film layer is configured such that the adhesion amount of conductive particles is set according to the required resistance value.

In the above configuration, the conductive film layer serves as a conductive pathway for diffusing or discharging static electricity charged on the outer surface of the vehicle body throughout the entire vehicle body while a vehicle is traveling. The adhesion amount of conductive particles to the conductive film layer is set according to the required resistance value. In other words, the resistance value of the conductive film layer is set depending on the adhesion amount of conductive particles. Therefore, it is possible to provide a face material having an electrostatic elimination function with the resistance value adjusted according to the requirements that vary depending on the vehicle models, specifications, and the like.

According to another aspect of the present disclosure, the conductive film layer may be configured such that the adhesion amount of the conductive particles is set by the ratio of the total area of the adhered area of the conductive particles to the area of the fiber layer and/or the film thickness of the conductive film layer.

In the above configuration, the resistance value is set by changing or setting the ratio of the total area of the adhered area of the conductive particles to the area of the fiber layer or the film thickness of the conductive film layer. Further, the adhesion amount of conductive particles may also be set by changing both the ratio of the total area of the adhered area and the film thickness. Therefore, the flexibility in setting the resistance value of the conductive film layer may be increased.

According to another aspect of the present disclosure, the face material may be disposed between the base material and the vehicle body. The conductive film layer may be formed on the surface on the vehicle body side of the fiber layer. The conductive film layer may have a protective layer laminated to the vehicle body side of the conductive film layer.

The protective layer protects the surface of the conductive film layer. It prevents the conductive particles that constitutes the conductive film layer from being rubbed or dislodged when in contact with the vehicle body or wiring members. This ensures that the electrostatic elimination effect provided by the lining material is maintained stably.

According to another aspect of the present disclosure, the fiber layer may be selected from a spunbonded nonwoven fabric or a spunlace nonwoven fabric.

Compared to other nonwoven fabrics, these nonwoven fabrics have superior smoothness on their surfaces and are easy to process to adhere conductive particles. Therefore, they are suitable as a base fiber layer that forms a conductive film layer.

Vehicle interior/exterior materials according to another aspect of the present disclosure have a base material and the face material. The face material is placed between the base material and the vehicle body, and may include a protective layer to maintain the electrostatic elimination effect.

Therefore, the vehicle interior/exterior materials are provided with a face material having a conductive film layer in which the adhesion amount of conductive particles is set according to the required resistance value. It is possible to provide vehicle interior/exterior materials with resistance values set according to requirements that vary depending on the vehicle models, specifications, and the like.

Another aspect of the present disclosure is a method of manufacturing a face material that is integrally arranged with a base material of a vehicle interior/exterior material. A conductive film layer is formed by adhering conductive particles to at least some areas on one side of a fiber layer, which is a sheet-like nonwoven fabric. The resistance value of the conductive film layer in the manufacturing method is set by adjusting the adhesion amount of the conductive particles.

With the adhesion amount of the conductive particles, the resistance value of the conductive film layer may be set according to the requirements. The conductive film layer in the face material serves as a conductive pathway for diffusing or discharging static electricity charged on the outer surface of the vehicle body while the vehicle is traveling. Therefore, it is possible to provide face materials for vehicle interior/exterior materials with the resistance value adjusted according to the requirements that vary depending on the vehicle models and specifications.

In another aspect of the present disclosure, the conductive film layer formation process involves setting the adhesion amount of the conductive particles by the ratio of the total area of the adhered area of the conductive particles to the area of the fiber layer and/or the film thickness of the conductive film layer.

Therefore, the resistance value of the conductive film layer is set according to the adhesion amount of conductive particles, which can be adjusted based on the requirements of different vehicle models and specifications. The adhesion amount of conductive particles may also be set by changing both the ratio of the total area of the adhered area of the conductive particles and the film thickness. Therefore, the flexibility in setting the resistance value of the conductive film layer may be increased.

In another aspect of the present disclosure, the conductive film layer formation process may involve adhering the conductive particles by intaglio printing.

By using intaglio printing, conductive particles may be partially placed on the fiber layer. Furthermore, the total area of the adhered area of the conductive particles may be set by changing the number of cells in the intaglio plate as needed. The size and depth of the cells in the intaglio plate may be changed as needed to set the film thickness of the conductive film layer. In other words, the adhesion amount of conductive particles may be set according to the required resistance value. Therefore, the flexibility in setting the resistance value of the conductive film layer may be improved.

In another aspect of the present disclosure, the face material is placed between the base material and the vehicle body. A protective layer formation process may be included in which a conductive film layer is formed on the surface on the vehicle body side of the fiber layer, and a protective layer is laminated on the vehicle body side of the conductive film layer.

This may protect the surface of the conductive film layer. It is possible to prevent conductive particles constituting the conductive film layer from being rubbed or dislodged when in contact with the vehicle body. Therefore, it is possible to manufacture a lining material that can maintain the electrostatic elimination effect stably.

The method of manufacturing vehicle interior/exterior materials according to another aspect of the present disclosure includes a lamination process in which the face material manufactured by the above manufacturing method is laminated on the surface on the vehicle body side of the base material.

The face material contributes to vehicle performance by incorporating a conductive film layer that helps eliminate static electricity charged on the outer surface of the vehicle body. This reduction in static electricity minimizes air resistance, which can improve the driving performance and steering stability of the vehicle. By ensuring smoother airflow around the vehicle, the face material helps maintain optimal vehicle dynamics and enhances overall performance. The face material includes a conductive film layer with the adhesion amount of conductive particles set according to the required resistance value. Therefore, it is possible to provide vehicle interior/exterior materials with the resistance value of the face material set according to the requirements that vary depending on the vehicle models, specifications, and the like.

### BRIEF DESCRIPTION OF THE FIGURES

FIG. 1 is a schematic view of a vehicle interior material mounted on a vehicle.

FIG. 2 is a cross-sectional schematic view of the vehicle interior material according to the embodiment.

FIG. 3 is a cross-sectional schematic view of a lining material according to the embodiment.

FIG. 4 is a schematic view of conductive particles connected to each other.

FIG. 5 is an illustration showing one example of the arrangement pattern of conductive film layers in the vehicle interior material.

FIG. 6 is a schematic view illustrating a state in which a conductive film layer is formed on a fiber layer, and a protective layer is further laminated.

FIG. 7 is a schematic view illustrating a state in which the positive (+) charge charged on the outer surface of a vehicle body is statically eliminated.

### DETAILED DESCRIPTION

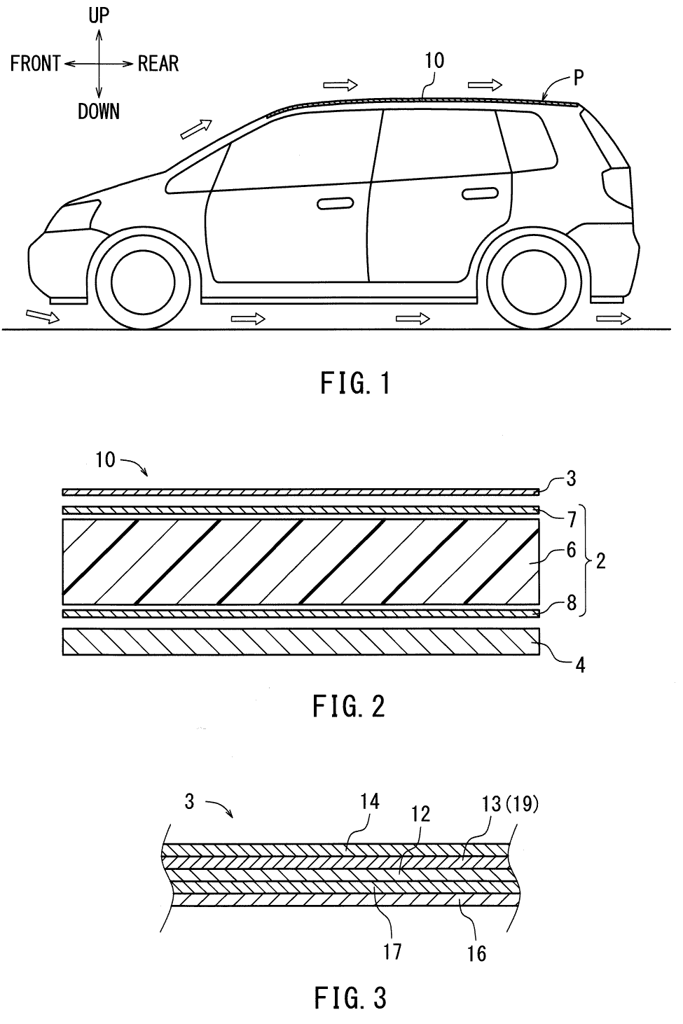

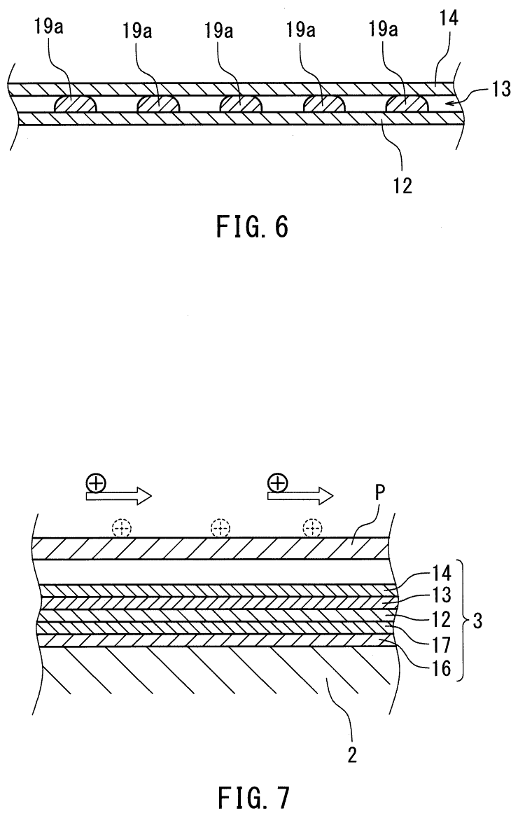

Hereinafter, an embodiment of the present disclosure will be described with reference to the drawings. In this embodiment, a molded ceiling material 10 will be described as an example of a vehicle interior/exterior material. The vehicle includes a ceiling panel P made of steel as a roof. As shown in FIG. 1, the molded ceiling material 10 is a vehicle interior material that is attached to the vehicle interior side of this ceiling panel P. The molded ceiling material 10 has a laminate, as shown in FIG. 2. The laminate includes a base material layer 2 (base material), a lining material 3 (face material), and a skin material 4. The laminate may be heat- and pressure molded, for example, by a hot press. The cross sections shown in FIG. 2, FIG. 3, FIG. 6 and FIG. 7 in the present embodiment, the upper side of the sheet is a ceiling panel P (vehicle body) side and the lower side is a vehicle interior side.

The lining material 3 is arranged on the ceiling panel P side (vehicle body side) of the base material layer 2. In the present embodiment, the lining material 3 corresponds to a face material that is integrally arranged with the base material layer 2 (base material). As shown in FIG. 3, the lining material 3 has a fiber layer 12, a conductive film layer 13 formed on the surface on the ceiling panel P side of the fiber layer 12, a protective layer 14 formed on the ceiling panel P side of the conductive film layer 13, and a barrier layer 16 laminated on the surface on the base material layer 2 side (vehicle interior side) of the fiber layer 12. The fiber layer 12 and the barrier layer 16 are bonded face-to-face via an adhesive resin layer 17 (adhesive resin).

The fiber layer 12 is a sheet-like nonwoven fabric, such as spunbonded or spunlace nonwoven fabric. Spunbonded nonwoven fabrics are formed as follows. First, continuous long fibers obtained by melting and spinning raw resin are directly accumulated to form a sheet-like fiber web. The fiber web is then bonded together using the thermal bonding process, which is a thermocompression bonding process with these fiber webs laminated in multiple layers. Spunbonded nonwoven fabrics have high strength against tension because of the use of long fibers. Spunlace nonwoven fabrics are formed as follows. For example, a sheet-like fiber web is formed from short fibers by a dry process. A high-pressure water jet is injected into the fiber web in a columnar manner to intertwine the fibers in the web. Spunlace nonwoven fabrics are formed by tightly entangling fibers to achieve high strength. The surfaces of spunbonded and spunlace nonwoven fabrics are smoother than those of other nonwoven fabrics, making it easier to apply printing and other processes described below.

For example, the main raw materials for the nonwoven fabric constituting the fiber layer 12 may be selected from, for example, PET (polyester) fibers and PP (polypropylene) fibers. Various synthetic fiber nonwoven fabrics, such as polyamide-based, polyester-based, polyacrylnitrile-based, etc., may be applied to the fiber layer 12.

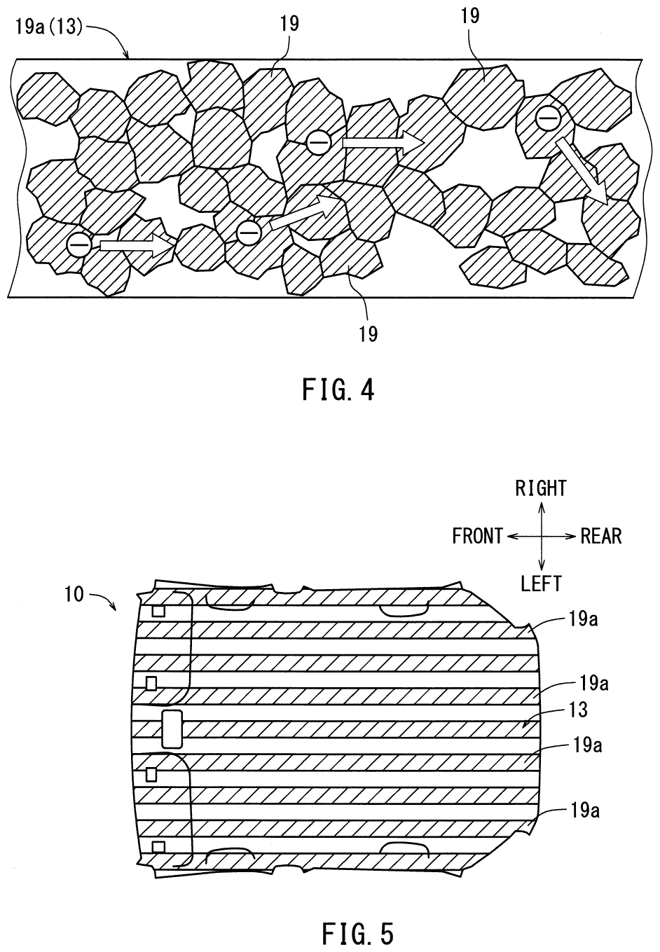

The conductive film layer 13 includes conductive particles 19 adhered to at least some areas on one side of the fiber layer 12 (surface on the ceiling panel P side). The conductive film layer 13 therefore serves as a conductive pathway through which electric charges can move. Specifically, the conductive film layer 13 has a printed coating of conductive particles 19 formed by a printing process on the surface on the ceiling panel P side of the fiber layer 12. For example, intaglio printing, such as gravure printing, may be selected as an example of the printing process. As shown in FIG. 4, free electrons may be allowed to move in the conductive film layer 13 as the conductive particles 19 connect with each other. Then, when the lining material 3 faces the ceiling panel P (vehicle body), static electricity charged on the outer surface of the vehicle body while the vehicle is traveling may diffuse throughout the entire vehicle body. Or, static electricity charged on the outer surface of the vehicle body may be discharged. Even if the lining material 3 is not in contact with the ceiling panel P (vehicle body), the electrostatic elimination effect can be obtained.

For the conductive film layer 13, the adhesion amount of conductive particles 19 is set according to the required resistance value. The resistance value refers to a level of difficulty for the flow of electricity, that is, the value representing electrical resistance. The resistance value of the conductive film layer 13 is appropriately set within the range that achieves an effective electrostatic elimination effect. In general, a resistance value in the range of 10¹ Ω to 10⁹ Ω allows static electricity to be easily released, and a resistance value in the range of 10¹ Ω to 10⁵ Ω allows static electricity to be released more quickly. The resistance value of the conductive film layer 13 may be 10⁹ Ω or higher, as long as it is within the range where elimination of static electricity is possible.

Conductive materials that form the conductive film layer 13 may include, for example, carbon-based materials, organic-based materials and metal-based materials. For carbon-based materials, for example, carbon nanotubes, carbon black, and fullerenes may be selected. As organic-based materials, polythiophene-based, polyacetylene-based, polyaniline-based, PEDOT (polyethylene dioxythiophene)-based, ITO (indium tin oxide)-based, FTO (fluorine-doped tin oxide), and polypyrrole conductive materials may be selected. Copper paste, silver paste, silver nanowires, etc. may be selected as metal-based materials. The conductive material may also be composed of a combination of multiple materials from the ones listed above. These materials can be used individually or in combination to form the conductive film layer 13, depending on the specific requirements and configuration of the fiber layer 12. In forming the conductive film layer 13, the conductive material and resin are mixed and applied to one side of the fiber layer 12.

The distribution pattern of the conductive particles 19 that form the conductive film layer 13 varies and may be selected as appropriate. In the example shown in FIG. 5, in the molded ceiling material 10, the adhered areas 19a to which the conductive particles 19 are adhered are arranged in strips at predetermined intervals. For example, by changing the width of these adhered areas 19a as needed, the adhesion amount of conductive particles 19 may be set according to the required resistance value to adjust the resistance value of the conductive film layer 13. The distribution pattern of the conductive particles 19 may be, for example, in a manner where the strip-shaped adhered areas 19a are orthogonal to the width direction (left-right direction) of the molded ceiling material 10. They may also be arranged at an angle to the longitudinal direction (front-rear direction) and width direction. They may also be arranged in a grid pattern.

For the conductive film layer 13, the adhesion amount of conductive particles 19 is set by the ratio of the total area of the adhered area 19a of the conductive particles 19 to the area of the fiber layer 12 (e.g., the area of the molded ceiling material 10) or the film thickness of the conductive film layer 13. In other words, the resistance value of the conductive film layer 13 is also set by altering the ratio of the total area of the adhered area 19a of the conductive particles 19 or the film thickness of the conductive film layer 13. The adhesion amount of the conductive particles 19 may be set by changing both the ratio of the total area of the adhered area 19a of the conductive particles 19 and the film thickness of the conductive film layer 13 to determine the resistance value of the conductive film layer 13. By increasing or decreasing the total area 19a where the conductive particles 19 are adhered, the resistance value can be changed accordingly. The conductive film layer 13 may also be configured to have partially different film thicknesses.

By selecting a conductive material that is relatively prone to carry a negative (−) charge in the charging series, the conductive film layer 13 easily carries a negative (−) charge on the ceiling panel P side while the vehicle is traveling. This negative (−) charge may then lower the positive (+) charge charged on the outer surface of the ceiling panel P. Furthermore, the positive (+) charge is allowed to flow (diffuse) via the conductive film layer 13 to the entire vehicle body, thereby releasing static electricity charged on the outer surface of the vehicle body.

As shown in FIG. 3, a protective layer 14 is laminated on the ceiling panel P side of the conductive film layer 13. The protective layer 14 protects the surface of the conductive film layer 13. For example, the protective layer 14 prevents the conductive particles 19 constituting the conductive film layer 13 from being rubbed or dislodged when in contact with the ceiling panel P or wiring members. The protective layer 14 is composed of, for example, an overprint varnish. For example, medium or varnish may be selected for the material that may be used for the protective layer 14. Non-toluene type or non-formaldehyde type materials are more preferable for the material that constitutes the protective layer 14.

The barrier layer 16 is a non-breathable film, for example, a cast polypropylene (CPP) film may be selected. The adhesive resin layer 17 is provided to bond the barrier layer 16 and the fiber layer 12, for example, extruded polypropylene may be selected.

As shown in FIG. 2, the base material layer 2 includes a porous core material 6 and fiber-reinforced layers 7 and 8 laminated on both sides of the core material 6. The base material layer 2 is solidified with thermosetting adhesive or the like. The core material 6 is typically made of semi-rigid urethane foam, providing shape and rigidity of the molded ceiling material 10, and is formed into a surface shape along the surface of the ceiling panel P.

The first fiber-reinforced layer 7 is laminated to the surface on the ceiling panel P side of the core material 6, and the second fiber-reinforced layer 8 is laminated to the surface on the vehicle interior side. The first and second fiber-reinforced layers 7 and 8 are provided to maintain the shape and ensure the rigidity of the molded ceiling material 10. These fiber-reinforced layers 7 and 8 are coated or impregnated with thermosetting adhesive (thermoplastic resin) on the surface and are bonded to both sides of the core material 6, respectively. A glass fiber mat is selected for the first and second fiber-reinforced layers 7 and 8. The glass fiber mat is formed into a sheet with chopped strands of glass fiber, an inorganic fiber, cut to an appropriate length and solidified with an appropriate binder. A nonwoven fabric protecting the surface of the second fiber-reinforced layer 8 may be laminated on the vehicle interior side of the second fiber-reinforced layer 8. For example, needle-punched nonwoven fabrics may be selected for this nonwoven fabric.

These fiber-reinforced layers 7 and 8 may be made of glass fibers solidified with a binder without cutting (continuous mat). Instead of this, spunlace, spunbonded nonwoven fabric, glass paper, or glass fiber woven fabric may also be used. The weight per unit area in the embodiment may be selected to meet the required strength and various other conditions.

The fiber-reinforced layers 7 and 8 may be made of inorganic fibers such as chopped strands or organic fibers such as jute, kenaf, ramie, hemp, sisal hemp, bamboo, or other natural fibers selected as appropriate, and then formed into sheets or mats by acrylic or other binders or needle processing.

A thermosetting resin consisting of isocyanate resin may be selected as the thermosetting adhesive resin. Isocyanate is favorable from the perspective of easy affinity with the core material 6 made of urethane foam in the semi-rigid layer. The thermosetting adhesive is not limited to isocyanate resin, but may be selected as appropriate. The thermosetting adhesive is applied by spray or roll coater. As described above, the strength of the molded ceiling material 10 may be increased by using a configuration in which the fiber-reinforced layers 7 and 8 containing thermosetting resin and the core material 6 are laminated.

The skin material 4 is disposed on the vehicle interior side of the base material layer 2 as a part that serves as a design surface of the molded ceiling material 10. The skin material 4 may be selected, for example, from a laminate of a surface layer and a urethane foam sheet. The surface layer may be applied in a variety of ways, such as textile including fabric, cloth, knitted fabric, or other fabric member including woven fabric, non-woven fabric, raised fabric, or synthetic leather, artificial leather, genuine leather, etc. Urethane foam sheets are laminated by applying a soft layer made of urethane resin foam to the molded ceiling material 10 to obtain a soft touch. It is also possible to have a structure without laminating the urethane foam sheet.

### Manufacturing Process of Lining Material

Next, the manufacturing method of a lining material 3 (face material) according to the above embodiment will be described. As shown in FIG. 3, the manufacturing process of the lining material 3 includes a conductive film layer formation process in which a conductive film layer 13 is formed on one side of the fiber layer 12, a protective layer formation process in which a protective layer 14 is laminated on the conductive film layer 13, and a first lamination process in which a barrier layer 16 is laminated on the surface on the base material layer 2 side of the fiber layer 12.

As shown in FIG. 6, in the conductive film layer formation process, conductive particles 19 are adhered to at least some areas on one side of the fiber layer 12. Specifically, the conductive particles 19 are partially placed on the fiber layer 12 by printing. For example, intaglio printing, such as gravure printing, is used to adhere conductive particles to the fiber layer 12 in the conductive film layer formation process. In gravure printing, conductive ink, which is made by mixing conductive particles 19 and binder resin into a liquid, is adhered to the cells (depression of a concave shape) of a cylindrical intaglio cylinder. A doctor blade is used to scrape off excess conductive ink on the intaglio surface. The fiber layer 12 is clamped between the compression roller and the intaglio cylinder, transferring the conductive ink from the cells to the fiber layer 12. The fiber layer 12 with the conductive ink transferred is then dried in a dryer. As a result, a conductive film layer 13 is formed. In the conductive film layer 13, conductive particles 19 are connected to each other on the surface of the fiber layer 12 to form conductive pathways to allow electric charge to be transmitted.

In the conductive film layer formation process, the adhesion amount of conductive particles 19 is set according to the required resistance value of the conductive film layer 13. In the case of intaglio printing, the total area of adhered area 19a of the conductive particles 19 is set by changing the number of cells in the intaglio plate as appropriate. By changing the size and depth of the cells in the intaglio plate as appropriate, the film thickness of the conductive film layer 13 is set. As a result, the adhesion amount of conductive particles 19 may be set. The conductive film layer 13 may also be configured to have partially different film thicknesses.

As shown in FIG. 5, the conductive particles 19 are arranged, for example, in strips at predetermined intervals. The conductive particles 19 may be arranged in various patterns. The adhesion amount of conductive particles 19 is set according to the required resistance value of the conductive film layer 13. For example, the ratio of the total area of the adhered area 19a of the conductive particles 19 to the area of the fiber layer 12 (molded ceiling material 10) may be changed accordingly. This sets the adhesion amount of conductive particles 19. By changing the film thickness of the conductive film layer 13 as appropriate, the adhesion amount of conductive particles 19 is set. Both the total area of the adhered area 19a and the film thickness of the conductive film layer 13 may be changed. This may set the adhesion amount of conductive particles 19 and the resistance value of the conductive film layer 13.

As shown in FIG. 6, in the protective layer formation process, a protective layer 14 is further laminated on the conductive film layer 13. Specifically, for example, the protective layer 14 is formed by coating the adhered area 19a of conductive particles 19 with overprinting varnish.

In the first lamination process, as shown in FIG. 3, the barrier layer 16 is laminated to the fiber layer 12. Specifically, the barrier layer 16 is laminated via an adhesive resin layer 17 on the surface opposite to the side where the conductive film layer 13 and the protective layer 14 of the fiber layer 12 are formed, typically bonded via an adhesive resin layer. In the manufacturing process of the lining material 3, the first lamination process may be performed after the conductive film layer formation process and the protective layer formation process. The conductive film layer formation process and the protective layer formation process may be performed after the first lamination process.

### Manufacturing Process for Molded Ceiling Materials

Next, a manufacturing method of the molded ceiling material 10 (vehicle interior/exterior material) according to the above embodiment will be described. As shown in FIG. 2, the method of manufacturing the molded ceiling material 10 includes a second lamination process in which a base material layer 2 (base material), a lining material 3 (face material), and a skin material 4 are laminated, and a molding process in which the laminate is press-molded.

In the second lamination process, a lining material 3 manufactured through the manufacturing process of the lining material 3 is arranged on the surface on the vehicle body side of the base material layer 2. The skin material 4 is placed on the surface on the vehicle interior side of the base material layer 2. As a result, a laminate is formed. The lining material 3 is arranged on the ceiling panel P side, with the surface on the side where the conductive film layer 13 and the protective layer 14 are formed on the fiber layer 12. The barrier layer 16 is arranged on the base material layer 2 side.

In the molding process, the laminate formed in the second lamination process is heat- and pressure molded, for example, by a hot press so as to be integrated.

The molded ceiling material 10 molded through the above process is arranged on the ceiling panel P of the vehicle body as a vehicle interior material. As shown in FIG. 7, it is known that a positive (+) charge tends to be charged on the outer surface of the vehicle body while the vehicle is traveling. A positive (+) charge is charged on the outer surface of the ceiling panel P. At this time, the negative (−) charge of the conductive film layer 13 in the lining material 3 of the molded ceiling material 10 moves to the ceiling panel P side. This neutralizes and eliminates the positive (+) charge charged in the ceiling panel P. The positive (+) charge is diffused via the conductive film layer 13 throughout the entire vehicle body. This allows static electricity to be released. By allowing electric charges to move through the conductive film layer 13, it helps neutralize and eliminate positive static charges on the vehicle body, thereby reducing air resistance and improving driving performance and steering stability. The conductive film layer 13 can reduce the potential of the positive (+) charge charged on the outer surface of the ceiling panel P. Therefore, the increase in air resistance on the outer surface of the vehicle body is suppressed. The driving performance and steering stability of the vehicle may be maintained.

### Effects of the Embodiment

The lining material 3 (face material) of the molded ceiling material 10 (vehicle interior/exterior material) according to the above embodiment has a fiber layer 12 made of a nonwoven fabric sheet and a conductive film layer 13 formed on one side of the fiber layer 12. The conductive film layer 13 is composed of conductive particles 19 adhered to at least a part of the surface of the fiber layer 12. The conductive film layer 13 serves as a conductive pathway for diffusing or discharging static electricity charged on the outer surface of the vehicle body while the vehicle is traveling throughout the entire vehicle body as the lining material 3 faces the ceiling panel P (vehicle body). The adhesion amount of conductive particles 19 on the conductive film layer 13 is set according to the required resistance value. In other words, the resistance value of the conductive film layer 13 is set according to the adhesion amount of conductive particles 19. Therefore, it is possible to provide a lining material 3 having an electrostatic elimination function with the resistance value adjusted according to the requirements that vary depending on the vehicle models, specifications, and the like.

For the lining material 3 according to the above embodiment, the ratio of the total area of the adhered area 19a of the conductive particles 19 to the area of the fiber layer 12, or the film thickness of the conductive film layer 13 is changed and set. In this way, the adhesion amount of conductive particles 19 is set according to the required resistance value. The adhesion amount of conductive particles 19 can also be set by changing both the ratio of the total area of the adhered area 19a and the film thickness. Thus, the flexibility in setting the resistance value of the conductive film layer 13 may be increased.

The lining material 3 according to the above embodiment is disposed between the base material layer 2 (base material) and the ceiling panel P (vehicle body). The lining material 3 has a conductive film layer 13 formed on the surface of the fiber layer 12 on the ceiling panel P side (vehicle body side). A protective layer 14 is laminated on the ceiling panel P side of the conductive film layer 13. This protects the surface of the conductive film layer 13. It is possible to prevent conductive particles 19 constituting the conductive film layer 13 from being rubbed or dislodged when in contact with the vehicle body or wiring members. Therefore, the electrostatic elimination effect provided by the lining material 3 may be maintained stably.

For the lining material 3 according to the above embodiment, spunbonded nonwoven fabrics or spunlace nonwoven fabrics are selected as the fiber layer 12. Compared to other nonwoven fabrics, spunbonded nonwoven fabrics and spunlace nonwoven fabrics have superior smoothness on their surfaces and are easier to process to adhere conductive particles 19. Therefore, they are suitable as a base fiber layer 12 that forms a conductive film layer 13.

For the lining material 3 according to the above embodiment, a material is selected that is easily charged with a relatively negative (−) charge as the conductive material constituting the conductive film layer 13. As a result, a negative (−) charge is transmitted to the vehicle body side (e.g., the ceiling panel P side) of the conductive film layer 13 while the vehicle is traveling. The positive (+) charge charged on the outer surface of the vehicle body is neutralized and eliminated. The potential of the positive (+) charge on the outer surface of the vehicle body decreases. Therefore, a greater electrostatic elimination effect may be exerted.

The lining material 3 (face material) according to the above embodiment has a conductive film layer 13 formed by printing on the fiber layer 12, which is a sheet-like nonwoven fabric. For example, a thin nonwoven fabric is used for the fiber layer 12. This allows the thickness of the lining material 3 with the electrostatic elimination function to be made thinner. It is also easy to apply to vehicle interior/exterior materials with limited arrangement space.

The molded ceiling material 10 (vehicle interior/exterior material) according to the above embodiment includes a lining material 3 having a conductive film layer 13 with an adhesion amount of conductive particles 19 set according to the required resistance value. Therefore, the molded ceiling material 10 may be provided with a resistance value set according to the requirements that vary depending on the vehicle models, specifications, and the like. The molded ceiling material 10 is installed in the ceiling panel P, which occupies a large area in the vehicle body. Therefore, the lining material 3 of the molded ceiling material 10 is equipped with an electrostatic elimination function. This allows greater flexibility in the arrangement of the adhered area 19a of the conductive particles 19 according to the required resistance value. Thus, the flexibility in adjusting the resistance value of the conductive film layer 13 may be further improved.

According to the manufacturing process of the lining material 3 (face material) according to the above embodiment, the conductive particles 19 are adhered to at least a part of one side of the fiber layer 12 made of a nonwoven fabric sheet to form a conductive film layer 13. With this adhesion amount of the conductive particles 19, the resistance value of the conductive film layer 13 may be set according to the requirements. The conductive film layer 13 serves as a conductive pathway for diffusing or discharging static electricity charged on the outer surface of the vehicle body while the vehicle is traveling throughout the entire vehicle body as the lining material 3 faces the vehicle body. Therefore, the lining material 3 of the molded ceiling material 10 with a resistance value adjusted may be provided according to the requirements that vary depending on the vehicle models, specifications, and the like.

In the manufacturing process of the lining material 3 according to the above embodiment, the ratio of the total area of the adhered area 19a of the conductive particles 19 to the area of the fiber layer 12, or the film thickness of the conductive film layer 13 is changed and set. This method allows precise control over the adhesion amount and distribution of conductive particles 19 to be set according to the required resistance value, enabling the adjustment of the resistance value of the conductive film layer 13. The adhesion amount of conductive particles 19 may also be set by changing both the ratio of the total area of the adhered area 19a and the film thickness. Thus, the flexibility in setting the resistance value of the conductive film layer 13 may be increased.

In the manufacturing process of the lining material 3 according to the above embodiment, the conductive particles 19 are attached to one side of the fiber layer 12 by a printing process in the conductive film layer formation process. By using the printing process, the conductive particles 19 can be partially placed on the fiber layer 12. Furthermore, if intaglio printing is selected, the total area of the adhered area 19a of the conductive particles 19 may be set by changing the number of cells in the intaglio plate as appropriate. Further, the size and depth of the cells in the intaglio plate can be changed during the printing process to set the film thickness of the conductive film layer 13. Thicker films generally have lower resistance, while thinner films have higher resistance. In other words, the adhesion amount of conductive particles 19 can be set according to the required resistance value. Therefore, the flexibility in setting the resistance value of the conductive film layer 13 may be improved.

In the manufacturing process of the lining material 3 according to the above embodiment, the protective layer 14 is further laminated to the conductive film layer 13 formed on the surface on the ceiling panel P side (vehicle body side) of the fiber layer 12. This protects the surface of the conductive film layer 13 and can prevent the conductive particles 19 constituting the conductive film layer 13 from being rubbed or dislodged when in contact with the vehicle body. Therefore, it is possible to manufacture the lining material 3 that can maintain a stable electrostatic elimination effect.

According to the method of manufacturing the molded ceiling material 10 (vehicle interior/exterior material) according to the above embodiment, the molded ceiling material 10 is manufactured with the lining material 3 (face material) having an electrostatic elimination function. The lining material 3 has a conductive film layer 13 with the adhesion amount of conductive particles set according to the required resistance value. Therefore, the molded ceiling material 10 may be provided with a resistance value set according to the requirements that vary depending on the vehicle models, specifications and the like.

### Other embodiments

Face materials for vehicle interior/exterior materials may be applied to various vehicle interior/exterior components, enhancing their functionality and performance. For example, they may be applied as face materials for interior and exterior components such as shades, door trims, trunk sides, trunk lid, trunk upper, dash outer, dash inner, rear parcel shelf, package trim, front pillars, center pillars, rear pillars, as well as ceilings. The face material is integrally arranged with the base material of the vehicle interior/exterior materials. The face material is placed on one side of the base material according to the arrangement configuration of the vehicle interior/exterior materials. The face material may be placed between the base material of the vehicle interior/exterior material and the vehicle body, or it may also be placed as an intermediate layer in the base material of the vehicle interior/exterior materials.

The manufacturing process of the lining material 3 (face material) according to the above embodiment may be applied to the manufacturing process for face materials of other vehicle interior/exterior materials.

The base material of a vehicle interior/exterior material may be composed of a fiber body containing, for example, thermoplastic synthetic resin and a fiber reinforcement material such as glass fiber. The base material may also be composed solely of a fiber body containing thermoplastic resin. The vehicle interior/exterior materials may be molded via a second lamination process in which the base material and the face material are laminated, and a molding process in which the laminate of the base material and the face material is heated and pressure molded by, for example, a hot press.

The face material of the vehicle interior/exterior materials and its manufacturing method, and the vehicle interior/exterior materials and their manufacturing method shall not be limited to the appearance and configuration described in the above embodiments, and may be implemented in various other forms by various changes, additions, deletions, and combinations of configurations without departing from the scope of the invention.

In the above embodiments, an example of forming a conductive film layer by intaglio printing has been described, however other printing methods may also be selected. For example, a conductive film layer may be formed by adhering conductive particles to the fiber layer by letterpress printing, such as flexographic printing, or screen printing. The conductive film layer may also be formed by adhering a coating film of conductive particles by a coating process.

In the above embodiments, although an example has been described in which conductive particles are placed in some areas on the side of the fiber layer to constitute a conductive film layer, it may also be configured in which conductive particles are placed on the entire surface of the fiber layer (e.g., the entire surface of the molded ceiling material).

The face material of vehicle interior/exterior materials may be configured to serve as a conductive pathway when connected to the vehicle body, as it comes into contact with the vehicle body. For example, the lining material of the above molded ceiling material may have a shape with a part of the base material layer protruding such that the lining material of the molded ceiling material partially comes in contact with the ceiling panel.

The face material of vehicle interior/exterior materials may be configured without a protective layer, depending on its arrangement configuration.

Although an example of a configuration in which a core material of urethane foam and a fiber-reinforced material are laminated has been described as the configuration of the base material layer of the molded ceiling material 10 according to the above embodiment, various configurations may be applied without being limited thereto. For example, a molding laminated with a nonwoven fabric on both sides of the core material containing glass fibers and thermoplastic resin, or a molded nonwoven fabric, may be selected as the configuration of the base material layer.

What is claimed is:

1. A face material integrally arranged with a base material of vehicle interior/exterior materials comprising:
a fiber layer that is a sheet-like nonwoven fabric, wherein the nonwoven fabric is selected from the group consisting of spunbonded nonwoven fabric, spinlace nonwoven fabric, and any combination thereof; and
a conductive film layer including conductive particles adhered to at least some areas on one side of the fiber layer, wherein a resistance value of the conductive film layer is set by adjusting adhesion amount of the conductive particles.

2. The face material according to claim 1, wherein the conductive film layer is configured such that the resistance value of the conductive film layer is set by a ratio of a total area of an adhered area of the conductive particles to an area of the fiber layer and a film thickness of the conductive film layer.

3. The face material according to claim 1, wherein the face material is disposed between the base material and a vehicle body, wherein the conductive film layer is formed on a surface of a vehicle body side of the fiber layer, and wherein the face material includes a protective layer laminated to the vehicle body side of the conductive film layer.

4. The face material according to claim 3, wherein the fiber layer is selected from the group consisting of spunbonded nonwoven fabric, a spunlace nonwoven fabric, and any combination thereof.

5. The face material according to claim 1, wherein the adhesion amount of the conductive particles is adjusted by
changing a number of cells in an intaglio plate,
altering a size and depth of the cells to set the film thickness, and
varying the ratio of the conductive particles to an area of the fiber layer.

6. The face material according to claim 5, wherein a thicker film thickness has a lower resistance value, and wherein a thinner film thickness has a higher resistance value.

7. The face material according to claim 1, wherein the resistance value is adjusted accordingly by increasing or decreasing the total area where the conductive particles are adhered.

8. A vehicle interior/exterior material comprising:
a base material and a face material according to claim 1, wherein the face material is disposed between the base material and a vehicle body.

9. A method of manufacturing a face material of a vehicle interior/exterior material that is integrally arranged with a base material of the vehicle interior/exterior material, the method comprising:
forming a conductive film layer by adhering conductive particles to at least some areas on one side of a fiber layer;
setting a resistance value by adjusting adhesion amount of the conductive particles; and
forming a protective layer, wherein the protective layer is laminated on a vehicle body side of the conductive film layer.

10. The method according to claim 6 further comprising changing a ratio of a total area of an adhered area of the conductive particles to an area of the fiber layer, and altering a film thickness of the conductive film layer.

11. The method according to claim 6, wherein the conductive particles are adhered by intaglio printing.

12. The method according to claim 6, wherein the face material is disposed between the base material and a vehicle body, and wherein the conductive film layer is formed on a surface on a vehicle body side of the fiber layer, and a protective layer is laminated on the vehicle body side of the conductive film layer.

13. The method according to claim 6 further comprising a step of laminating a barrier layer by laminating the fiber layer via an adhesive resin layer.

14. The method according to claim 10, wherein the barrier layer is a non-breathable film.

15. The method according to claim 14, wherein the non-breathable film is polypropylene.

16. The method of claim 6 further comprising a step of laminating the base material, wherein the face material is arranged on a surface on the vehicle body side of the base material.

17. The method of claim 12 further comprising a step of laminating a skin material, wherein the skin material is placed on a surface on a vehicle interior side of the base material to form a laminate.

18. The method of claim 13 further comprising a step of molding the laminate, wherein the laminate is integrally heat and pressure-molded.

19. The method of claim 14, wherein the heat and pressure-molding step is a hot press.
